(19) United States
(12) Patent Application Publication
(10) Pub. No.: US 2021/0201843 A1
(43) Pub. Date: Jul. 1, 2021

(54) BASES INTERFACING WITH ELECTRONIC DEVICES

(71) Applicant: HEWLETT-PACKARD DEVELOPMENT COMPANY, L.P., Spring, TX (US)

(72) Inventors: Christopher RIJKEN, HOUSTON, TX (US); Chih Liang LEE, Taipei City, Taiwan Province (CN); Jeffrey C. STEVENS, HOUSTON, TX (US)

(73) Assignee: HEWLETT-PACKARD DEVELOPMENT COMPANY, L.P., Houston, TX (US)

(21) Appl. No.: 16/075,638

(22) PCT Filed: Jul. 17, 2017
(86) PCT No.: PCT/US2017/042328

§ 371 Date: Aug. 4, 2018

(51) Int. Cl. G09G 5/00

(52) U.S. Cl. CPC G09G 5/006; G09G 2370/12; G09G 2340/04

(57) ABSTRACT

Examples disclosed herein provide an electronic device. One example electronic device includes a housing, a display panel stored in the housing, a base connector to interface with a base that provides structure support for the housing, and a controller connected to the base connector. The controller is to determine a type of the base via the base connector and set an input source of the controller based on the type.

### BACKGROUND

All-in-one (AiO) computing systems are gaining popularity due to the compact overall design and functionality. For example, connections between the monitor, processor, and hardware components are made within the housing of the AiO computing system. As a result, the physical wiring and connections that can clutter a separated computer and monitor may be hidden.

### BRIEF DESCRIPTION OF THE DRAWINGS

FIGS. 1A-B illustrate block diagrams of an electronic device that may interface with different types of bases, according to an example;

FIGS. 2A-B illustrate an electronic device that may interface with a base, according to an example;

FIG. 3 illustrates a set of signals the base provides when the electronic device is connected to it, according to an example; and

FIG. 4 illustrates an electronic device for determining the type of base connected to it, according to an example.

### DETAILED DESCRIPTION

Examples described herein provide the ability for different types of bases to be used in an AiO computing system. As the AiO computing system evolves, updated designs are separating the monitor and some associated hardware components from a base that includes the main processor. This separated design reduces the likelihood that certain components may become obsolete over time. Also, the separated design enables the AiO computing system to be used even if either the monitor or base fails, for example, by replacing only the failed component.

As an example, a two-way communication bus between the monitor and the base may be used to facilitate communications between each other. By providing an interface that allows for different types of bases to be used, in addition to allowing a compute base to interface with the monitor to create the AiO computing system, a non-computing base, or display base, may also interface with the monitor to create, as an example, a standard monitor or docking platform for notebook computers. As will be further described, a controller may determine the type of base currently connected to the monitor, in order to process the signals received from the base, such as the video signal.

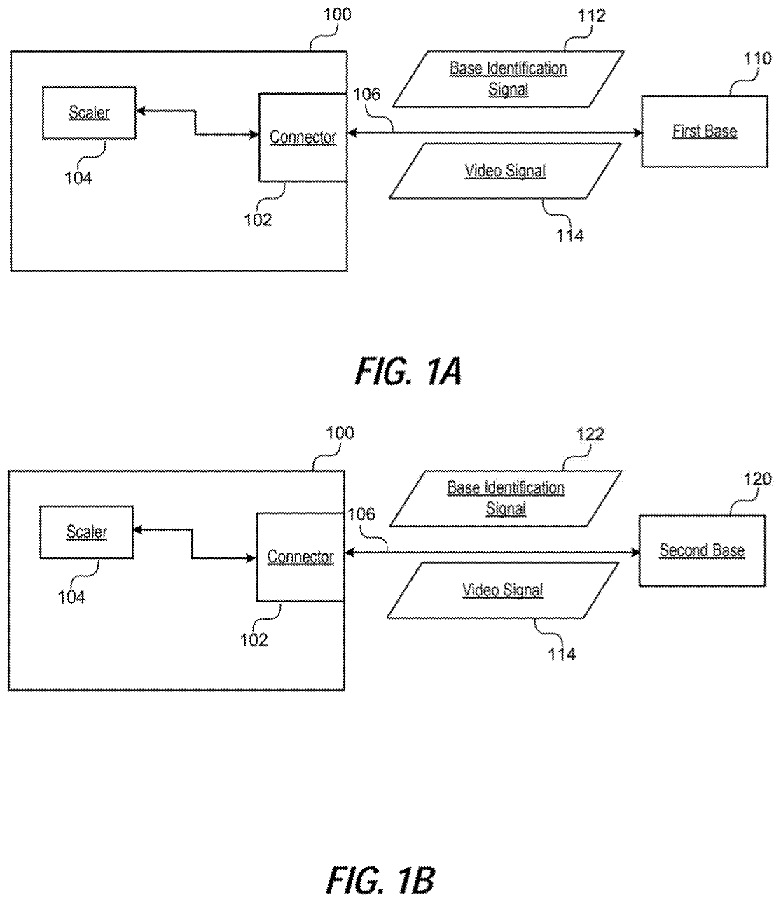

With reference to the figures. FIGS. 1A-B illustrate block diagrams of an electronic device 100 that may interface with different types of bases, according to an example. The electronic device 100 may be part of an AiO computing system that interfaces with a base via a connection component 106 that may include a two-way communication bus. The two-way communication bus provides a communication path to allow data, or communication signals, to be exchanged between the electronic device 100 and base.

Referring to FIG. 1A, the electronic device 100 includes a base connector 102 that interfaces with a first base 110 having a first type (e.g., compute base). Similarly, referring to FIG. 1B, the base connector 102 of the electronic device 100 interfaces with a second base 120 having a different type than the first type (e.g., non-computing base or display base). The electronic device 100 and the associated base may be coupled together via the connection component 106. Physical connections and wiring used to connect components in the electronic device 100 to components in the associated base may be run through the connection component 106. As will be further described, the base connector 102 receives a set of signals from the base.

The electronic device 100 includes a housing that stores a display panel for displaying output from the base currently connected to the electronic device 100 (e.g., first base 110 or second base 120). The electronic device 100 may include a controller 104 connected to the base connector 102, such as a video scaler, for processing signals received from the base, such as video signal 114. As an example, based on the type of base currently connected to the electronic device 100 via the connector 102, the scaler 104 sets an input source of the scaler 104 or sets a processing format to a video format that processes the video signal 114 received from the base accordingly. In addition to the video signal 114, the base may provide a base identification signal, among other signals, for the scaler 104 to determine the type of base connected to the electronic device 100.

Referring to FIG. 1A, the first base 110 provides a first base identification signal 112 to identify that the first base 110 is of a first type, such as a compute base. When the compute base 110 is connected to the base connector 102 of the electronic device 100, the electronic device 100 and compute base 110 together forms an AiO computer. As an example, upon receiving the first base identification signal 112 identifying a compute base, in order for the scaler 104 to process the video signal 114 received from the compute base 110, the scaler 104 may set the input source of the scaler 104 to an Embedded DisplayPort (eDP) video signal, or set a processing format to process the video signal 114 as an eDP video signal, or another standard where performance to display output from the compute base 110 is not compromised.

Similarly, referring to FIG. 1B, the second base 120 provides a second base identification signal 122 to identify that the second base 120 is of a different type than the first type, such as a non-computing base or display base. When the display base 120 is connected to the base connector 102 of the electronic device 100, the electronic device 100 and display base 120 together forms, as an example, a standard monitor or docking platform for notebook computers. As an example, comparing the compute base 110 of FIG. 1A to the display base 120 of FIG. 1B, the compute base 110 has a greater number of components than the display base 120. As an example, upon receiving the second base identification signal 122 identifying a display base, in order for the scaler 104 to process the video signal 114 received from the display base 120, the scaler 104 may set the input source of the scaler 104 to a High-Definition Multimedia Interface (HDMI) video signal, or set a processing format to process the video signal 114 as an HDMI video signal, or another standard that supports display bases, such as Digital Visual Interface (DVI).

In one example, an AiO computing system may be defined as a computing system where the electronic device 100 is coupled to a base, and physical wiring used to connect the electronic device 100 to the base are not visible. In other words, physical connections between the electronic device 100 and the base are located within the housing of the electronic device 100, the base (e.g., first base 110 or second base 120), and the connection component 106. Although the electronic device 100 and base may be located in separate housings, they are still part of the same computing system. For example, the housing of the electronic device 100 may be separate from the housing of the base. However, the electronic device 100 may be connected to the base via the connection component 106 to form the AiO computing system.

It should be noted that FIGS. 1A-B have been simplified for ease of explanation and that additional components and circuitry may be included that are not shown. For example, the base (e.g., first base 110 or second base 120) may include computer readable memory, graphics cards, motherboards, power supplies, external connection interfaces (e.g., universal serial bus (USB) interfaces), and the electronic device 100 may also include computer readable memory in communication with the scaler 104, motherboards, power supplies, and the like.

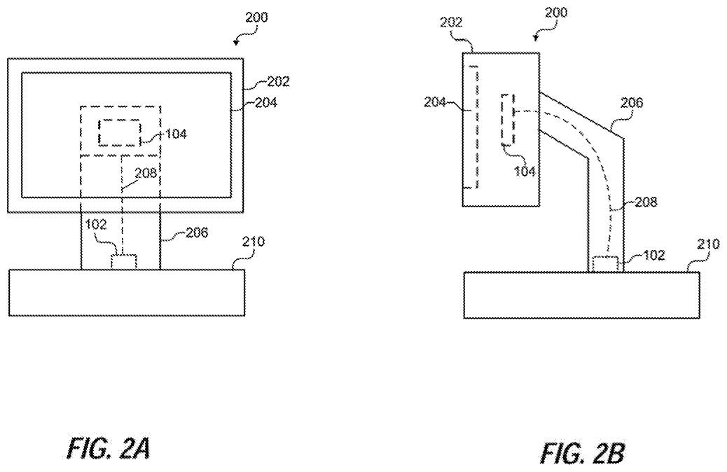

FIGS. 2A-B illustrate an electronic device 200 that may interface with a base 210, according to an example. Similar to electronic device 100, electronic device 200 may interface win bases of different types, such as a compute base or display base. The electronic device 200 includes a housing 202 that stores a display panel 204 for displaying output from the base currently connected to the electronic device 200 (e.g., base 210). As illustrated, the electronic device 200 includes a support arm 206 extending from a backside of the housing 202. As an example, the base connector 102 that interfaces with the base 210 is located at a bottom end of the support arm 206, and connection component 208 may facilitate communications between the base connector 102 and a controller, such as the scaler 104. By connecting the electronic device 200 to the base 210 via the base connector 102, the base 210 provides structure support for the housing 202 of the electronic device 200.

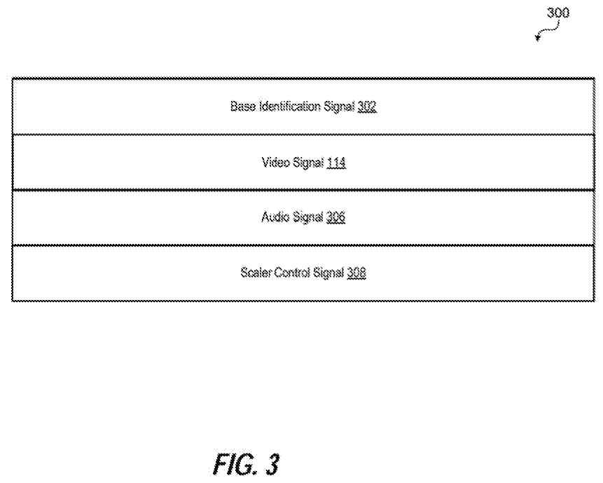

FIG. 3 illustrates a set 300 of signals a base provides when an electronic device is connected to it, according to an example. Referring back to FIGS. 2A-B, once electronic device 200 is connected to the base 210, base 210 may provide the set 300 of signals to the electronic device 200 for processing. For example, the base 210 provides base identification signal 302 for the scaler 104 to determine the type of base connected to the electronic device 200. For example, if the base identification signal 302 identifies that the base 210 is of a first type, such as a compute base, in order for the scaler 104 to process the video signal 114 received from the base 210, the scaler 104 may set the input source of the scaler 104 to an eDP video signal, or set a processing format to process the video signal 114 as an eDP video signal.

Similarly, if the base identification signal 302 is of a different type than the first type, such as a non-computing base or display base, in order for the scaler 104 to process the video signal 114 received from the base 210, the scaler 104 may set the input source of the scaler 104 to a HDMI video signal, or set a processing format to process the video signal 114 as an HDMI video signal. In addition to the base identification signal 302 and video signal 114, the set 300 of signals may include an audio signal 306 and scaler control signal 308, among others.

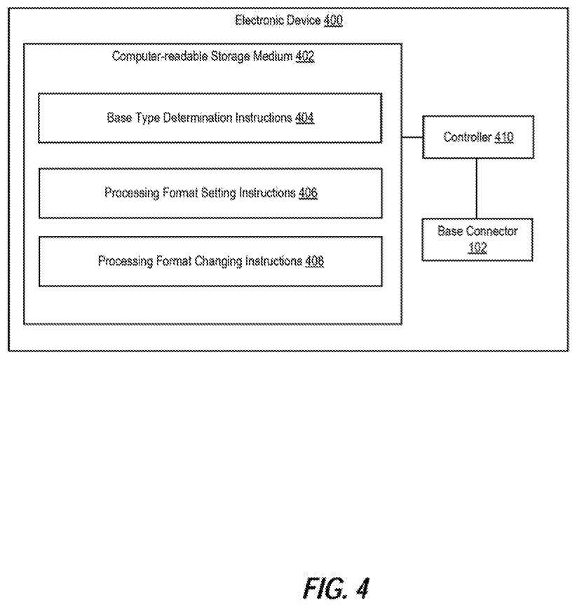

FIG. 4 illustrates an electronic device 400 for determining the type of base connected to it, according to an example. As described above, electronic device 400 may interface with bases of different types, such as a compute base or display base. The electronic device 400 depicts a controller 410 and a computer-readable storage medium 402 and, as an example of the electronic device 400 performing its operations, the computer-readable storage medium 402 may include instructions 404-408 that are executable by the controller 410. As an example, the controller 410 may determine the type of base currently connected to the electronic device 400, in order to process the signals received from the base, such as the video signal. As an example, the controller 410 corresponds to scaler 104.

Thus, computer-readable storage medium 402 can be said to store program instructions that, when executed by controller 410, implement the components of the electronic device 400. The executable program instructions stored in the computer-readable storage medium 402 include, as an example, base type determination instructions 404, processing format setting instructions 406, and processing format changing instructions 408.

Base type determination instructions 404 represent program instructions that, when executed by the controller 410, cause the electronic device 400, in response to establishing a first connection with a first base via the base connector 102, to determine a first type of the first base via the base connector 102. As described above, the type of the base may be determined via a base identification signal received from the base, via the base connector 102. As an example of the first type, the electronic device 400 may determine the first base as a compute base.

Processing format setting instructions 406 represent program instructions that, when executed by the controller 410, cause the electronic device 400 to set a processing format of a video signal received via the base connector 102 to a first video format based on the first type. As described above, upon receiving the base identification signal identifying the first base as a compute base, in order for the controller 410 to process the video signal received from the first base, the controller 410 may set the processing format to an eDP format for processing the video signal received from the first base.

Processing format changing instructions 408 represent program instructions that, when executed by the controller 410, cause the electronic device 400 to change the processing format to a second video format in response to determining that the base connector 102 is connected to a second base having a different type than the first type. As an example, the electronic device 400 may determine the second base as a non-computing base or display base. Therefore, upon receiving the base identification signal identifying the second base as a display base, in order for the controller 410 to process the video signal received from the second base, the controller 410 may change the processing format from the eDP format to an HDMI format for processing the video signal received from the second base.

Computer-readable storage medium 402 represents generally any number of memory components capable of storing instructions that can be executed by controller 410. Computer-readable storage medium 402 is non-transitory in the sense that it does not encompass a transitory signal but instead is made up of at least one memory component configured to store the relevant instructions. As a result, the computer-readable storage medium 402 may be a non-transitory computer-readable storage medium. Computer-readable storage medium 402 may be implemented in a single device or distributed across devices. Likewise, controller 410 represents any number of processors capable of executing instructions stored by computer-readable storage medium 402. Controller 410 may be integrated in a single device or distributed across devices. Further, computer-readable storage medium 402 may be fully or partially integrated in the same device as controller 410, or it may be separate but accessible to that device and controller 410.

In one example, the program instructions 404-408 can be part of an installation package that when installed can be executed by controller 410 to implement the components of the electronic device 400. In this case, computer-readable storage medium 402 may be a portable medium such as a CD, DVD, or flash drive or a memory maintained by a server from which the installation package can be downloaded and installed. In another example, the program instructions may be part of an application or applications already installed. Here, computer-readable storage medium 402 can include integrated memory such as a hard drive, solid state drive, or the like.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art, which are also intended to be encompassed by the following claims.

1. An electronic device comprising:
a housing;
a display panel stored in the housing;
a base connector to interface with a base that provides structure support for the housing; and
a controller connected to the base connector, wherein the controller is to:
determine a type of the base via the base connector; and
set an input source of the controller based on the type.

2. The electronic device of claim 1, wherein the controller is to:
set the input source to an Embedded DisplayPort (eDP) video signal when the type of the base is a compute base; and
set the input source to a High-Definition Multimedia Interface (HDMI) video signal when the type of the base is a display base.

3. The electronic device of claim 2, wherein the compute base has a greater number of components than the display base.

4. The electronic device of claim 1, wherein the controller is a video scaler.

5. The electronic device of claim 1, wherein the base connector is to receive a video signal, an audio signal, a scaler control signal, and a base identification signal.

6. An electronic device comprising:
a housing;
a display panel stored in the housing;
a base connector to interface with a base that provides structure support for the housing, wherein the base connector is to receive a set of signals from the base, wherein the set of signals include a base identification signal and a video signal, and wherein the base identification signal indicates a type of the base; and
a video scaler connected to the base connector, wherein the video scaler is to:
receive the video signal; and
set a processing format of the video signal based on the base identification signal.

7. The electronic device of claim 6, wherein the video scaler is to process the video signal as an Embedded DisplayPort (eDP) video signal based on the processing format.

8. The electronic device of claim 6, wherein video scaler is to process the video signal as a High-Definition Multimedia Interface (HDMI) video signal based on the processing format.

9. The electronic device of claim 6, further comprising a support arm extending from a backside of the housing, wherein the base connector is located at a bottom end of the support arm.

10. A non-transitory computer readable storage medium comprising instructions that when executed cause a controller of an electronic device to:
in response to establishing a first connection with a first base via a base connector, determine a first type of the first base via the base connector;
set a processing format of a video signal to a first video format based on the first type, wherein the video signal is received via the base connector; and
change the processing format to a second video format in response to determining that the base connector is connected to a second base having a different type than the first type.

11. The storage medium of claim 10, wherein the first video format is an Embedded DisplayPort (eDP) format.

12. The storage medium of claim 10, wherein the second video format is a High Definition Multimedia Interface (HDMI) format.

13. The storage medium of claim 10, wherein the controller is a video scaler.

14. The storage medium of claim 10, wherein the instructions to determine the first type of the first base include instructions to determine the first type of the first base via a base identification signal received via the base connector.

15. The storage medium of claim 10, wherein the video signal is received via the base connector.
